(19) United States
(12) Patent Application Publication
(10) Pub. No.: US 2010/0039521 A1
(43) Pub. Date: Feb. 18, 2010

(54) ELECTRONIC DEVICE WITH IMAGE ADJUSTMENT FUNCTION AND METHOD THEREOF

(75) Inventors: XIAO-GUANG LI, Shenzhen City (CN); CHIA-YU CHENG, Tu-Cheng (TW); KUAN-HONG HSIEH, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/253,936

(22) Filed: Oct. 17, 2008

(30) Foreign Application Priority Data
Aug. 12, 2008 (CN) 200810303699.3

(51) Int. Cl. H04N 5/228

(52) U.S. Cl. 348/222.1; 348/E05.031

(57) ABSTRACT

An image adjustment method includes providing an input unit configured for receiving inputs, obtaining a desired image and sending the desired image to the display unit, adjusting the desired image on the display unit according to the inputs, obtaining an adjusted desired part of the desired image, reducing a resolution of the adjusted desired part of the desired image according to a resolution of the display unit, and copying the reduced desired part of the desired image to a desired location. An electronic device with an image adjustment function is also provided.

### BACKGROUND

1. Technical Field

The present invention relates to an electronic device with a function of image adjusting in copying images and a method thereof.

2. General Background

Advancements in camera technology have led to increasing resolution capabilities for cameras. For images captured with a 3.1 megapixel camera, a file size will be at least 1 (MB). As a result, the effectiveness of memory cards is limited because they are unable to store a large number of images. A displayer can only display images that fit into its resolution, and many display devices have low resolution.

US publication application 2005/0135790, hereby incorporated by reference, discloses a method for reducing resolution of images to be commensurate with a display device for images. The method doesn't change ratios of items (e.g. head of people) in the image, which will result in a bad appearance of desired items in the image.

What is needed, therefore, is an electronic device with an image adjustment function that can adjust images when copying images and a method thereof.

### BRIEF DESCRIPTION OF THE DRAWINGS

The components of the drawings are not necessarily drawn to scale, the emphasis instead being placed upon clearly illustrating the principles of the electronic device with an image adjustment function that can adjust images when copying images and method thereof. Moreover, in the drawings, like reference numerals designate corresponding parts throughout the several views.

FIG. 1 is an exemplary block diagram for a hardware infrastructure of an electronic device with an image adjustment function in accordance with an exemplary embodiment.

FIG. 2 is a flowchart of an adjustment method implemented by the electronic device of FIG. 1 when copying images in accordance with an exemplary embodiment.

FIG. 3 is a display diagram of an image displayed in a normal display state by the electronic device of FIG. 1 in accordance with an exemplary embodiment.

FIG. 4 is another display diagram of the image of FIG. 3 displayed after being adjusted by the electronic device of FIG. 1 in accordance with an exemplary embodiment.

### DETAILED DESCRIPTION OF THE EMBODIMENTS

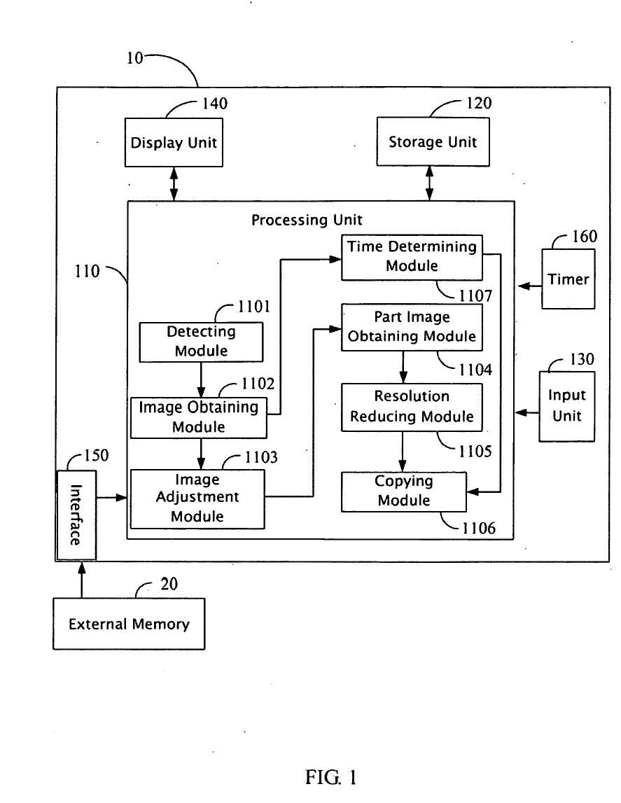

FIG. 1 is an exemplary block diagram for a hardware infrastructure of an electronic device with an image adjustment function. The electronic device 10 includes a processing unit 110, a storage unit 120, an input unit 130, a display unit 140, an interface 150, and a timer 160. The interface 150 is configured for connecting with an external memory 20. The external memory 20 may be, for example, SD cards, MD cards, MP3 players, and digital cameras.

The storage unit 120 is configured for storing images. The input unit 130 is configured for receiving a user's input, and sending a corresponding operation signal to the processing unit 110. The display unit 140 is configured for displaying the images. The timer 160 is configured for timing.

The processing unit 110 is configured for obtaining a desired image from the storage unit 120 or the external memory 20 according to the operation signal generated by the input unit 130, and displaying the desired image on the display unit 140. The processing unit 110 is further configured for adjusting the desired image according to the user's operation, for example, rotation, zooming, saving, capturing a part of the desired image, and reducing a resolution of the part of the desired image to be commensurate with the display unit 140, among other similar operations. The part of the desired image may be a part of the image on the display unit 140, or the part the user selects.

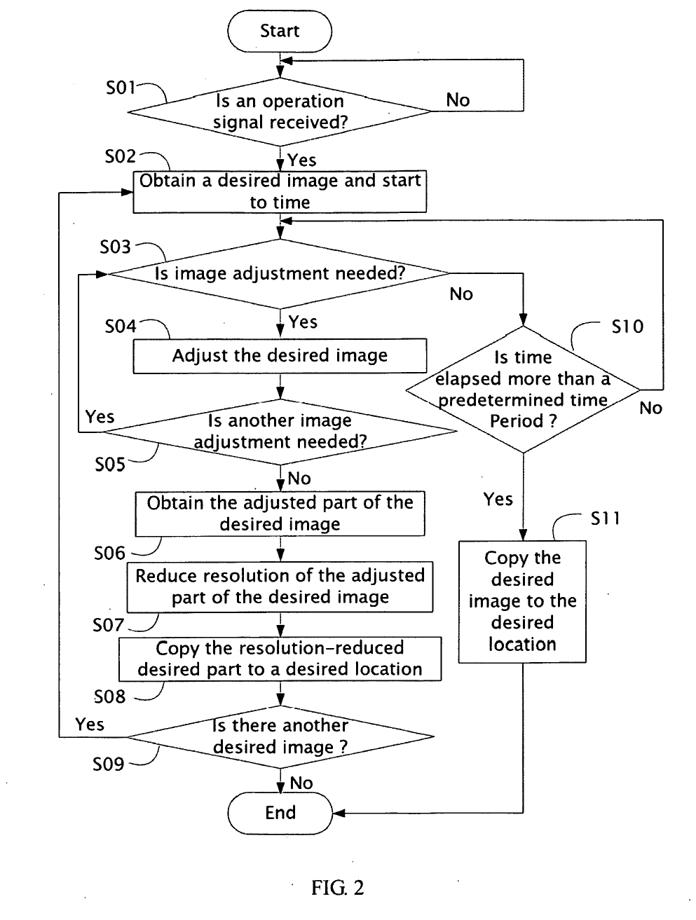

The processing unit 110 includes a detecting module 1101, an image obtaining module 1102, an image adjustment module 1103, a part image obtaining module 1104, a resolution reducing module 1105, a copying module 1106, and a time determining module 1107. The functions of the modules in the processing unit 110 are described below together with FIG. 2.

FIG. 2 is a flowchart of an adjustment method implemented by the electronic device 10. Depending on the embodiment, certain steps described below may be removed, while others may be added, and the sequence of steps may also be altered.

In step S01, the detecting module 1101 detects whether a copy operation signal generated from the input unit 130 has been received. The copy operation signal corresponds to an operation of copying at least one desired image from the storage unit 120 or the external device 20 to a desired location. The desired location is configured for storing the adjusted part of the desired images and may be the storage unit 120 or the external memory 20.

In step S02, if the copy operation signal generated from the input unit 130 has been received, the image obtaining module 1102 obtains one desired image from the storage unit 120 or the external device 20 according to a sorting criteria. The sorting criteria may be browsing time, file size, time of creation, and so on. At the same time, the image obtaining module 1102 notifies the user to adjust the desired image and starts the timer 160. The image obtaining module 1102 may generate a user interface including indicating information and send it on the display unit 140 to notify the user to adjust the desired image.

In decision step S03, the image adjustment module 1103 determines whether to adjust the desired image displayed on the display unit 140 according to the user's input. That is, the image adjustment module 1103 determines whether an adjusting operation signal is received in a predetermined time period. The adjusting operation signal corresponds to an adjustment operation, such as rotation, zoom in/out, and so on. If the image adjustment module 1103 does not receive the adjusting operation signal in the predetermined time period, the method continues to decision step S10 described below.

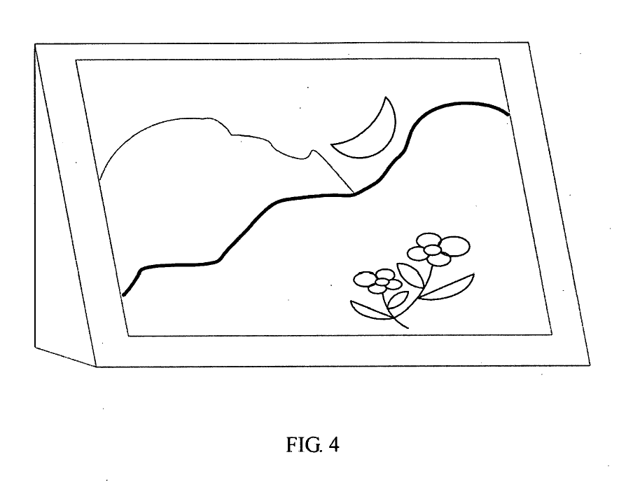

If the image adjustment module 1103 receives the adjusting operation signal in the predetermined time period, in step S04, the image adjustment module 1103 adjusts the desired image according to the adjusting operation signal. For example, as shown in FIG. 4, the image adjustment module 1003 zooms in the image in response to a zooming in operation.

In decision step S05, the image adjustment module 1103 determines whether the adjustment operation on the image has ended. This occurs when the image adjustment module 1103 determines that no operation signal has been received in a successive predetermined time period.

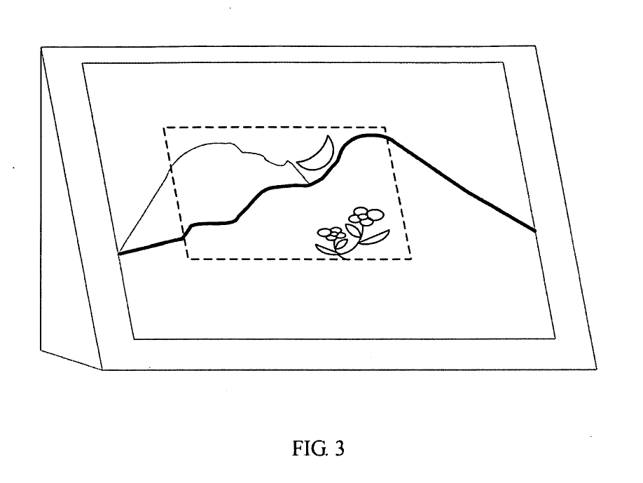

If no operation signal has been received in the successive predetermined time period, in decision step S06, the image adjustment module 1103 determines to end the adjustment operation on the desired image, and the part image obtaining module 1104 obtains the desired part of the desired image. The part of the desired image may be a selected part of the desired image on the display unit 104, or a visible part that is displayed on the display unit 104. For example, as shown in FIG. 3, a region surrounded by a broken line rectangle is the selected part of the desired image.

In step S07, the resolution reducing module 1105 reduces resolution of the desired part of the desired image according to the resolution of the display unit 140. Suppose that the resolution of the display unit 140 is 800×600, the resolution of the desired image is 2048×1536, and the resolution of the desired part of the image is 1600×1200, the resolution of the desired part of the desired image 1600×1200 is larger than the resolution of 800×600 of the display unit 140, the resolution reducing module 1105 reduces the resolution of 1600×1200 of the desired part of the desired image to 800×600.

In step S08, the copying module 1106 copies the resolution-reduced desired part of the desired image to the desired location.

In step S09, the image obtaining module 1102 detects whether there is another desired image to be copied according to the sorting criteria in step S02. If there is another desired image, the method continues to step S02, otherwise, the method ends.

In the decision step S10, the time determining module 1107 determines whether the time elapsed measured by the timer 160 is less than the predetermined time period. If the time of the timer 160 is less than the predetermined time period, the method proceeds to step S03. If the time of the timer 160 is equal to or greater than the predetermined period, the method continues to step S11.

In step S11, the copying module 1106 copies the desired image to the desired location, such as the storage unit 120 or the external memory 20.

Although the present invention has been specifically described on the basis of exemplary embodiments thereof, the invention is not to be construed as being limited thereto. Various changes or modifications may be made to the embodiment without departing from the scope and spirit of the invention.

What is claimed is:

1. An electronic device with an image adjustment function, comprising:
an input unit configured for receiving inputs;
a display unit for displaying images;
an image obtaining module capable of obtaining a desired image and sending the desired image to the display unit;
an image adjustment module capable of adjusting the desired image on the display unit according to the inputs;
a part image obtaining module capable of obtaining an adjusted desired part of the desired image;
a resolution reducing module capable of reducing a resolution of the adjusted desired part of the desired image according to a resolution of the display unit; and
a copying module capable of copying the reduced desired part of the desired image to a desired location.

2. The electronic device according to claim 1, wherein the desired part of the desired image is a selected part of the desired image selected by user's operation using the input unit.

3. The electronic device according to claim 1, wherein the desired part of the desired image is a visible part of the desired image on the display unit.

4. The electronic device according to claim 1, wherein the desired location is a storage unit in the electronic device or an external memory connected with the electronic device.

5. The electronic device according to claim 4, further comprising a timer and a time determining module, wherein the time determining module is capable of determining whether time that the timer times is equal to or greater than a predetermined time period, and upon a condition that the time elapsed is more than the predetermined time period, the copying module copies the desired image to the desired location.

6. An image adjustment method comprising:
providing an input unit configured for receiving inputs;
obtaining a desired image and sending the desired image to the display unit;
adjusting the desired image on the display unit according to the inputs;
obtaining an adjusted desired part of the desired image;
reducing a resolution of the adjusted desired part of the desired image according to a resolution of the display unit; and
copying the reduced desired part of the desired image to a desired location.

7. The method according to claim 6, further comprising determining whether time that the timer times is equal to or greater than a predetermined time period, and upon a condition that the time elapsed is more than the predetermined time period, the copying module copies the desired image to the desired location.
